(19) United States
(12) Patent Application Publication
(10) Pub. No.: US 2020/0412525 A1
(43) Pub. Date: Dec. 31, 2020

(54) BLOCKCHAIN FILESYSTEM

(71) Applicant: GRID7 LLC d/b/a TAEKION, Boulder, CO (US)

(72) Inventors: William Katsak, Doylestown, PA (US); James Barry, Castle Rock, CO (US)

(73) Assignee: GRID7 LLC d/b/a TAEKION, Boulder, CO (US)

(21) Appl. No.: 16/914,238

(22) Filed: Jun. 26, 2020

Related U.S. Application Data
(60) Provisional application No. 62/867,179, filed on Jun. 26, 2019.

(51) Int. Cl. H04L 9/06; H04L 9/32; G06F 16/13; G06F 16/182; G06F 16/18; G06F 16/178

(52) U.S. Cl. CPC H04L 9/0637; H04L 9/3247; H04L 9/0643; G06F 16/178; G06F 16/1837; G06F 16/1865; G06F 16/1815; G06F 16/137

(57) ABSTRACT

A blockchain file system provides access to a data storage volume on a blockchain. The blockchain volume is mounted by the host computing system in the same way as a conventional data storage volume from the perspective of the user space applications. The host computing system includes a local write-ahead blockchain journal that links bundles of mutations to the filesystem related to filesystem operations into a chain of digital signatures. One or more of the mutation bundles are included in a signed blockchain transaction that is broadcast to a network of the blockchain that, when confirmed into the blockchain, will carry out the filesystem operations on the blockchain data storage volume. Also provided is a novel blockchain addressing scheme, copy-on-write functionality, and de-duplication features write-ahead filesystem journal.

### CROSS-REFERENCE TO RELATED APPLICATIONS

This application is a non-provisional application claiming priority benefit of U.S. Provisional Patent Application No. 62/867,179, entitled “Blockchain File System,” filed Jun. 26, 2019, and incorporated by reference herein.

### BACKGROUND OF THE INVENTION

Computing systems must manage storage, retrieval, and modification of electronically stored data. Most computing systems use a type of filesystem wherein data is represented by “files” organized according to nested directories of files. The files may be used with filesystem operations such as read, write, open, create, close, etc. and process system controls such as fork, exec, wait, exit, etc. This allows for convenient management of electronic data in the computing system as is familiar to generations of system administrators and users.

Blockchains are shared ledgers that periodically update according to a set of consensus rules among a group of peers. Honest peers will apply the correct set of consensus rules and thus update the shared ledger in a way that will be accepted by other honest peers. Blockchains may be used to track a number of things such as “coins” in a virtual money system, provenance of goods, identity of users, among many other uses. One feature of blockchains is that they may be viewed as immutable ledgers that would be very difficult or impossible to rewrite. An attacker would need to acquire over half of the total network hash power (e.g., in a proof-of-work consensus system) or over half of the total digital assets (e.g., in a proof-of-stake consensus system) to modify the contents of a blockchain. Thus, a greater confidence may be had that data on a blockchain was not tampered with compared to other distributed computer filesystems that do not operate according to consensus rules.

Accordingly, there is a need for a computer filesystem that facilitates management of electronic data with the security aspects of a blockchain but in a way that will be familiar to existing system administrators and users.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a blockchain filesystem with a write-ahead journal local to a host computing system and a blockchain network remote from the host computing system in accordance with some embodiments.

FIG. 2 is a signal diagram of a relationship between components of the blockchain filesystem in accordance with some embodiments.

FIG. 3 is a block diagram of an example blockchain filesystem file tree in accordance with some embodiments.

FIG. 4 is a schematic diagram of a blockchain filesystem mutation and a blockchain filesystem mutation bundle in accordance with some embodiments.

FIG. 5 is a schematic diagram of a blockchain write-ahead journal entry and example journal entries on a blockchain write-ahead journal in accordance with some embodiments.

FIG. 6 is a schematic diagram of a blockchain filesystem volume descriptor, a blockchain filesystem inode, a data blocks field and a filesystem directory in accordance with some embodiments.

FIG. 7 is a schematic diagram of a blockchain filesystem wrapper object in accordance with some embodiments.

FIG. 8 is a schematic diagram of a blockchain filesystem blockchain address format in accordance with some embodiments.

FIG. 9 is a flowchart diagram of a host computing system workflow for a blockchain filesystem in accordance with some embodiments.

FIG. 10 is a diagram of a system that may be useful in implementing the blockchain filesystem in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

A Unix-style filesystem is a type of computer filesystem that is characterized by the set of linked structures that implement an indexed file and directory allocation scheme. This filesystem has its origin in the Unix operating system. Historically, a Unix-style filesystem is stored on a hard disk drive or partition thereof. A volume is an organizational structure consisting of a collection of files and directories with a common root directory and that typically resides on a single partition. A particular filesystem volume is described by a “super block” which contains information about the file volume itself, as well as a link to the root directory inode. Within the filesystem, files and directories are represented by structures known as “inodes”. An inode is a structure that contains information about the file, most importantly permissions, ownership information, and links/pointers to one or more data blocks that make up the file. In the case that an inode represents a directory rather than a standard file, the data blocks will contain mappings between file names and inodes representing other files. In the case where an inode represents a standard file, the data blocks contain the actual data that makes up the file. A file can be thought of as consisting of one or more data blocks that are concatenated to produce the entire file. The blocks themselves are not necessarily contiguously allocated on the disk, but are rather logically combined by the filesystem implementation.

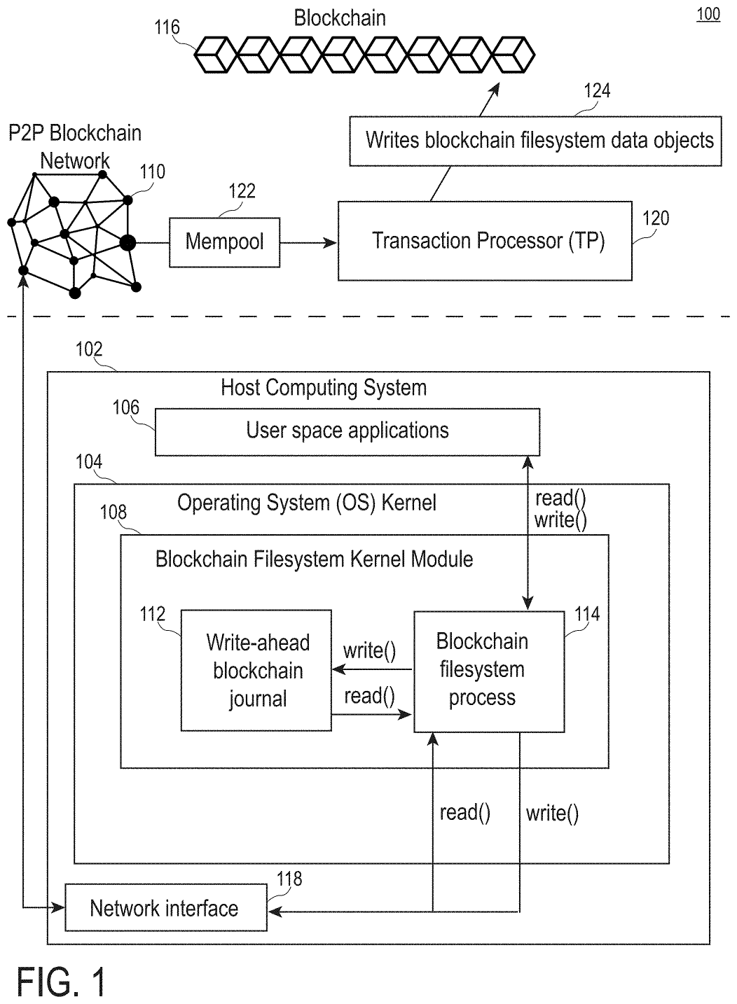

FIG. 1 is a block diagram 100 of a blockchain filesystem with a write-ahead journal 112 local to a host computing system 102 and a blockchain network 110 remote from the host computing system 102 in accordance with some embodiments. The blockchain filesystem will appear to function similar to a conventional computer filesystem, such as a Unix-style filesystem, to the users, but will leverage features of a blockchain (e.g., potential immutability, atomic commitment of a group of related file operations, distributed storage, etc.). The filesystem is an abstraction of the underlying blockchain data into a filesystem that will be familiar and usable to current computer system administrators and users. The blockchain filesystem thus makes it simple for blockchains to be simply integrated into complex computing environments while managing the underlying blockchain in a way transparent to the users.

The blockchain filesystem allows the host computing system 102 to mount a blockchain-based storage volume in a similar manner to how a computing system would mount a physical media drive to yield a mounted filesystem tree. Once mounted, user space applications 106 can submit filesystem operations to a blockchain filesystem kernel module 108 via a standardized filesystem access interface provided by the operating system. In the example illustrated in FIG. 1, the filesystem operations include read( ) and write( ), but other operations familiar to those skilled in the art are also possible (e.g., create( ), open( ), close( ), etc.). When the applications running in user space 106 submit their filesystem requests, the filesystem kernel module 108 can receive the requests via a blockchain filesystem process 114 and can handle the functions described herein with respect to carrying out the filesystem operations on the blockchain 116 via the peer-to-peer blockchain network 110 transparent to the user.

The blockchain filesystem process 114 writes to, and reads from, a write-ahead blockchain journal 112. The write-ahead blockchain journal 112 queues bundles of mutations, which are changes to the filesystem on the blockchain 116, that must be made in order to carry out the file operation requests from the user space application 106 on the host computing system 102. At appropriate times, mutation bundles waiting in the queue of the write-ahead blockchain journal 112 are synchronized to the blockchain 116, meaning mutation bundles in the queue are recorded to the blockchain 116. Once recorded to the blockchain 116, the recorded mutation bundles are trimmed (e.g., deleted) from the write-ahead blockchain journal 112, leaving only unrecorded mutation bundles in the queue.

Synchronizing mutation bundles in the write-ahead journal 112 to the blockchain 116 may require signing a valid blockchain transaction and submitting the signed blockchain transaction to at least one node on the peer-to-peer blockchain network 110 for propagation to the other nodes on the network. Typically, blockchain transactions are signed by a private cryptographic key that is part of a keypair with a public cryptographic key. Only certain public cryptographic keys are “whitelisted” into an access control list as being authorized to use the blockchain filesystem on the blockchain 116. Such whitelisted public keys can be part of the consensus rules applied by the nodes on the blockchain network 110. It is usually trivial computationally to verify whether a blockchain transaction has been signed by a private cryptographic key paired with a whitelisted public cryptographic key. To compose such a valid blockchain transaction, a component herein (e.g., the blockchain filesystem process 114) manages the private cryptographic keys and handles signing blockchain transactions therewith when it is time to broadcast a blockchain transaction to the network via the network interface 118 on the host computing system 102.

If a filesystem operation request from the user space applications 106 involves merely reading file(s) and/or directories from the blockchain 116, then there is no need to construct a signed blockchain transaction. Instead, the blockchain filesystem process 114 can parse a copy of the blockchain 116 obtained via the network interface 118 to find the requested data and return the data to the user space application 106.

In some implementations, the peer-to-peer blockchain network 110 includes a transaction processor 120 that can perform functions described herein. As one example, the transaction processor 120 may behave similar to a smart contract (e.g., a smart contract executing on the Ethereum network) in that valid blockchain transactions in the mempool 122 are not automatically committed to the blockchain 116, but rather the valid blockchain transactions in the mempool 122 cause the transaction processor 120 to take an action 124 (e.g., check to see if the data to be committed already exists on-chain, and, if so, do not make a duplicate of the existing data).

One potential issue with a blockchain that stores filesystem data is the fact that a blockchain is similar to an append-only database in that it only ever grows in size. Over time, the size of the chain could become unmanageable. It is therefore desirable to limit growth of the blockchain where possible. One way to limit the size of the chain is to use a deduplication function. The basis for the deduplication feature is the fact that every data block in the system has a hash digest output associated with it. A hash digest is like a fingerprint of the data block: two copies of identical data blocks will have identical fingerprints. Thus, before committing any changes to the blockchain, a participant (e.g., the transaction processor 120) can check whether the hash digest of the data to be committed matches the hash digest of any data already on the chain. If there is a match, committing the same data twice can be avoided by causing the inode that would have pointed to a block containing the duplicate data to instead point to the existing data block containing the matching data. This same mechanism can be leveraged to provide a filesystem feature known as “copy-on-write”. With copy-on-write, when a file is copied, a new inode is created for the target file, but the constituent data blocks are simply links to the data blocks that make up the source file. The term copy-on-write refers to the fact that a data block is only ever duplicated if a modification, or “write” necessitates it.

A key benefit provided by the blockchain filesystem is near complete data durability. In a normal operating mode, connected to the blockchain network 110, all writes are committed to the blockchain 116 “as soon as possible”, with feedback available to the administrator about the state of outstanding writes. Once a write has been committed to the blockchain, it can always be recovered, as it is part of the immutable blockchain history. In the case of a network partition (or any sort of interference) between the host computing system 102 and the blockchain network 110, the blockchain filesystem will have logged all writes to the local write-ahead blockchain journal 112. As long as the network disruption remains, writes can be read back from the local write-ahead blockchain journal 112 without interrupting continuing operations. When the network is restored, the writes queued in the journal are systematically committed to the blockchain and trimmed from the journal. This mechanism, combined with the volume-based structure, ensures that any data written during a network partition will eventually be committed to the blockchain in a way that maintains its original timestamps, ordering, and provenance.

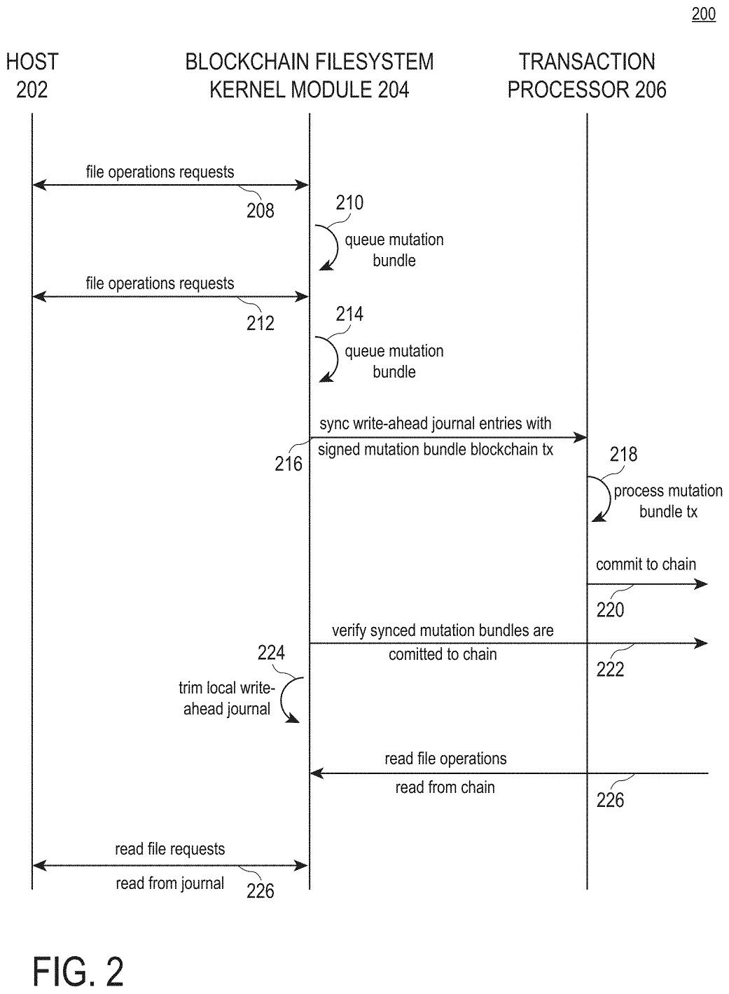

FIG. 2 is a signal diagram 200 of a relationship between components of the blockchain filesystem in accordance with some embodiments. The host computing system 202 has applications running in user space with filesystem operation requests regarding files (e.g., open, close, touch, append, write, read, etc.). These filesystem operation requests are submitted to the blockchain filesystem kernel module 204 at request operation 208, which is local to the host computing system 202. Each of the filesystem operation requests 208 can be viewed as a mutation to the filesystem in the sense that carrying out the filesystem operation requests 208 involves making some kind of change to the filesystem. For example, a request to append to an existing file would entail modifying the inode to increase the size of the file and adding links to new data blocks, as well as writing the new data blocks themselves. Subsequent file operations requests are submitted from the host computing system 202 and queued as mutation bundles by the blockchain filesystem kernel module 204 at queue operation 214.

Unlike in a conventional filesystem with a write-ahead journal, the blockchain filesystem kernel module 204 does not write the queued mutation bundles to a local storage media. Often such conventional write-ahead journals queue changes only until such time as the local storage media workload permits committing the changes (e.g., when the local storage media is idle, changes in the journal can be committed). The blockchain filesystem kernel module 204, on the other hand, synchronizes the mutation bundles with a blockchain. In other words, every change to the filesystem is recorded on the blockchain shared ledger instead of to local storage media. This results in a fundamentally different type of filesystem wherein all filesystem operations are recorded in an immutable ledger. Even disk operations that “delete” data on the filesystem do not truly delete the data because the data is still part of the immutable history of the blockchain. A delete filesystem operation in this context means only that the deleted data is not part of the filesystem at the tip of the chain as of the confirmation of the delete operation into the blockchain.

In the example implementation illustrated in FIG. 2, a transaction processor 206 receives the synchronization operation 216 and performs an ordering operation 218 on received mutation bundles. The synchronization operation 216 may include the blockchain filesystem kernel module 204 signing a valid blockchain transaction with a private cryptographic key paired with a public key whitelisted by the transaction processor 206. The transaction processor 206 could thus be replaced with a smart contract or other similar component that can determine which data from the signed blockchain transaction is actually committed to the chain.

One example of a way in which the transaction processor 206 (or similar component, e.g., a smart contract, a subset of blockchain validators, etc.) can process the signed blockchain synchronization transaction 216 from the blockchain filesystem kernel module 204 is for the transaction processor 206 to “order” the received mutation bundles in the operation 218. Ordering mutation bundles can include arranging the mutation bundles such that the mutation bundles are applied in a correct order (e.g., chronologically) to the blockchain filesystem. In other examples, the operation 218 could include a deduplication operation wherein data synchronized with the blockchain filesystem kernel module 204 that is duplicate to data already stored on the blockchain is not stored twice. Deduplication can include comparing a hash digest output (e.g., a SHA-256 hash) of data requested to be committed to the blockchain with the hash digest output of all data blocks already committed to the blockchain to determine whether the data requested to be written is a duplicate of existing data or not.

The blockchain filesystem disclosed herein thus offers fundamentally different features from existing blockchain-based file storage systems because the system disclosed herein is actually storing a copy of the filesystem data itself and not just storing a hash digest of the data. Other systems may purport to be blockchain-based file storage, but these systems are storing the filesystems themselves on centralized, non-blockchain computer systems. These other systems may allow a user to cryptographically prove that a certain data block existed at a certain point in time. To prove this, a hash digest of the data block must exist at a block height in the blockchain which was confirmed prior to that certain point in time (see, e.g., the genesis block on the bitcoin blockchain includes a newspaper headline published by the London Times on Jan. 3, 2009, thus proving the chain existed on or after that date). Being able to prove the existence of a data block as of a certain date may be useful, but it does not permit the full range of filesystem operations, or really any filesystem operations, provided herein such that a user can seamlessly mount the filesystem just like any other drive and perform the user's desired computing activities but now with the entire filesystem, and filesystem history, backed by the unique features of a blockchain (e.g., immutability, distributed storage, resistance to attack, etc.).

The result of the operation 218 is confirmed to a blockchain at operation 220. The blockchain filesystem kernel module 204 then can check a copy of the blockchain at operation 222 to confirm the requested mutation bundles have been confirmed (e.g., by using a block explorer-style website connected to one of the nodes on the peer-to-peer network of the blockchain to search for the signed blockchain transaction of operation 216). Once the blockchain filesystem kernel module 204 has confirmed a mutation bundle has been confirmed to the blockchain, a trim operation 224 can remove the confirmed mutation bundle(s) from the local journal, thus shortening the journal queue.

Whenever the host computing system 202 submits a read request 226 for a file or directory on the filesystem, the blockchain filesystem kernel module 204 can read the data from a copy of the blockchain retrieved from a full node on the blockchain network.

The availability and security of the filesystem described herein is thus derived differently from other filesystems. While other filesystems may have redundancy, backups, error checking, etc., none of them are storing data or backups on a ledger that cannot be altered without attacking a blockchain network. Depending on the consensus mechanism for the blockchain in question it can be incredibly expensive to attack, thus providing the users with an unmatched level of security against attackers who may wish to edit their data.

Certain use cases are especially suited to the blockchain filesystem due to the way a blockchain stores data. A blockchain is similar to an append-only database where additional valid blocks may be added but earlier blocks may not be changed or removed. If a participant tried to edit an earlier block in the chain, the edited block's hash digest would change. This would cause all subsequent blocks to also become invalid because the hash digest of all subsequent blocks, which are based on the original block's hash digest, will also change. On a proof-of-work blockchain, an attacker would have to re-compute the proof-of-work calculations for every block after the edited block. These calculations increase in complexity rapidly, thus forming the basis for the blockchain's security assurances. Since re-writing the blockchain is resource intensive, a user of the blockchain filesystem can have a high degree of confidence that not only will the files be preserved, but the history of the files will be preserved.

One of the use cases that is novel with regard to other blockchain-based file storage systems is a “snapshot” feature. When each mutation bundle is committed atomically to the blockchain, it becomes part of the blockchain's record at the block height at which the mutation bundle is confirmed. A blockchain filesystem kernel module 204 might normally respond to read file operations 226 by reference to the most up-to-date version of the blockchain available. Doing so would provide a “current” version of the filesystem to the user. If the user requests a snapshot, on the other hand, the user can specify a particular block height occurring in the past as the reference point for the filesystem operations. The user will effectively view the state of the filesystem as the filesystem existed at the specified block height. The response to a read request on a file will therefore depend on whether the user is asking for the file as it exists at the tip of the chain or at an earlier point in the chain (e.g., a lower blockheight) before a subsequent edit. In this way, the user can travel back in time through prior versions of the entire filesystem and retrieve earlier copies of files due to their permanent storage on the blockchain.

Another use case is the storage of logs on a computer system. If an attacker gains access to a computer system and engages in unauthorized behavior, the unauthorized behavior is usually reflected in the logs of whichever running programs the attacker accessed. A sophisticated attacker knows this, and may attempt to try to cover their tracks by editing log files to remove evidence of the unauthorized activities.

On a conventional filesystem, it can be forensically difficult to detect such a log edit. Even other blockchain-based file storage systems will not be able to respond as effectively to an attacker log edit as can the present system. Other systems can only detect a change in the hash digest of a file. The hash digest cannot be decoded to show a human or machine-readable file state nor show what changed in the file to result in a new hash digest. A log file is typically updated on an ongoing basis as a program executes. Some programs may be constantly writing to their log files, thus changing the hash digest output. There would be no way to analyze these hash digests to determine what change the attacker made to the log file as would be possible in the present system using the snapshot feature to examine the state of the filesystem at a blockheight after the attacker performed the unauthorized activities but before they performed the log edits.

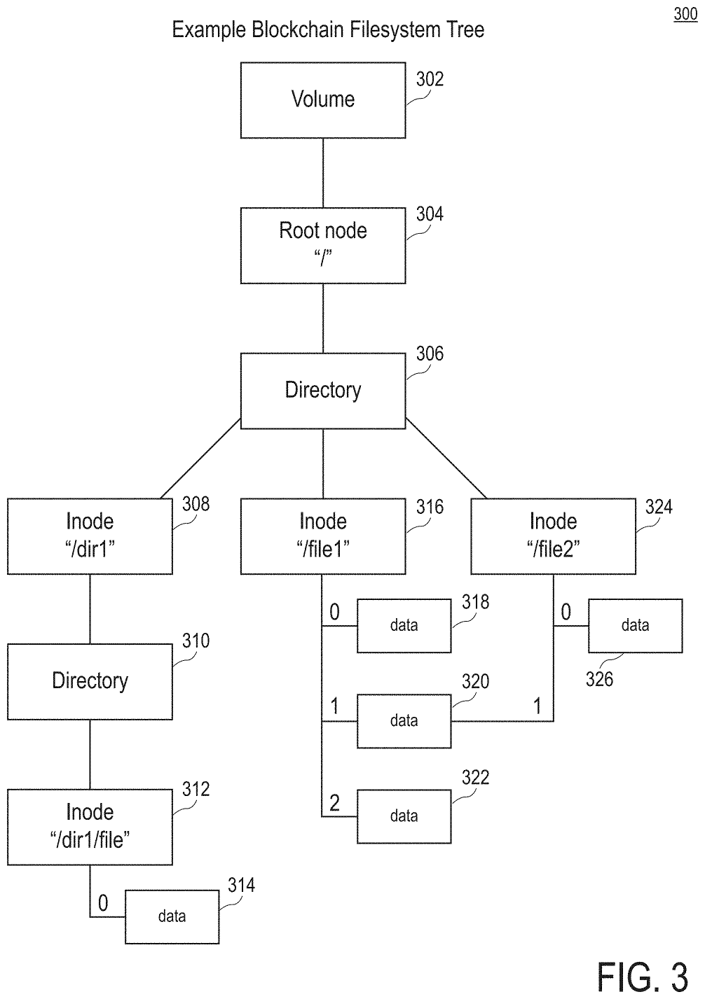

FIG. 3 is a block diagram of an example blockchain filesystem file tree in accordance with some embodiments. This diagram illustrates a Blockchain Filesystem volume, represented by volume structure 302. Volume structure 302 contains metadata and other information about the volume, as well as a link to the root inode 304.

Root inode 304 represents the root directory of the filesystem volume, or path “/”. As with all inodes, the root inode contains information common to all inodes, including user and group ownership information, permission bits, and creation/modification timestamps. Root inode 304 is by definition a directory, so it links to a directory structure 306. Directory structure 306 contains directory entries, which consist of file name to inode mappings, for three files: “/dir1”-mapped to directory inode 308, “/file1”—mapped to regular file inode 316, and “/file2”—mapped to regular file inode 324.

Directory inode 308 links to a directory structure 310, which contains an entry to a single regular file inode 312. Inode 312 is a regular file that consists of a single data block 314, indexed as block 0.

Inode 316 is a regular file that consists of three data blocks 318, 320, 322, indexed as blocks 0, 1, and 2 respectively, from the perspective of the file. Data block 320 is shared with file inode 324. The fact that data block 320 is shared means that this block is identical in both files. This sharing could have come about due to either a copy-on-write scenario, or as a result of deduplication independent of an explicit copy.

Inode 324 is a regular file that consists of two data blocks 326 and 320, indexed as blocks 0 and 1 respectively from the perspective of the file. As described in the previous paragraph, data block 320 is shared with mode 316 due to a copy-on-write or deduplication scenario.

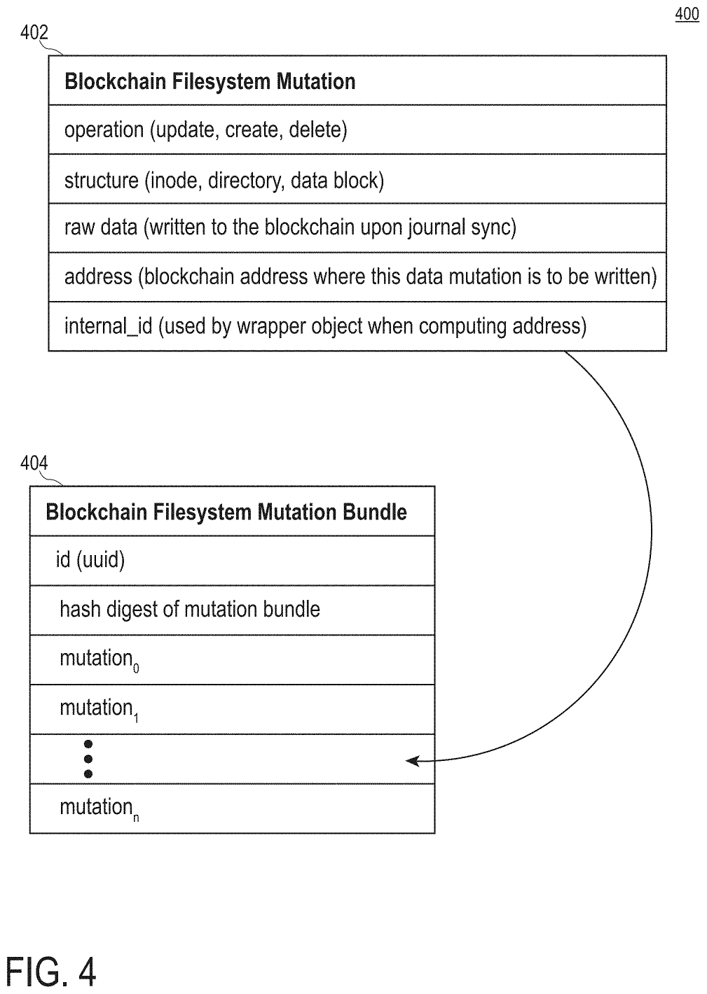

FIG. 4 is a schematic diagram 400 of a blockchain filesystem mutation 402 and a blockchain filesystem mutation bundle 404 in accordance with some embodiments. A mutation 402 in the context of this disclosure is a file operation that modifies a single object on a filesystem.

A mutation bundle 404 can modify several objects on the filesystem in a single change. As an example, the host operating system may send a write request that represents appending data to an existing file on the filesystem. Such a write request would involve modifying an mode and adding a data block to the file to which the data is to be appended. It would not be desirable to modify only the mode or only add the data block because then the mode that represents the file would have a length for the file that is either too long or too short. If such a partial change were to be recorded, then the filesystem could become corrupted.

The blockchain filesystem prevents splits of file operations that should be made together by virtue of the nature of blockchain transactions. Either a blockchain transaction is valid and added to the blockchain by the validators or the transaction is not added. There is not a way to partially confirm a transaction to a blockchain. Thus, any mutation bundle 404 including file operations that should be executed atomically (e.g., all changes in the bundle should be performed) is not at risk of only partially committing changes and thus corrupting the filesystem because the mutation bundle 404 is bundled into a blockchain-based transaction.

Use of blockchain transactions to atomically commit mutation bundles to the filesystem to avoid partial commits that would likely corrupt the filesystem avoids the need to implement complicated locking mechanisms, such as those found on conventional filesystems. In the absence of a blockchain transaction-based mutation bundle commit solution, a locking mechanism would need to be able to reverse partially committed filesystem operations if an atomic bundle of changes could not be completely committed. In some situations, in a conventional filesystem (e.g., an unplanned system shutdown, sudden removal of physical drive media, etc.), the locking mechanism may fail to ensure the atomicity of the mutation bundle and corrupt the drive. The blockchain transaction-based mutation bundles are therefore an improvement to the functioning of a filesystem because they are a technical solution that increases the reliability of the system and hardens it against filesystem corruption.

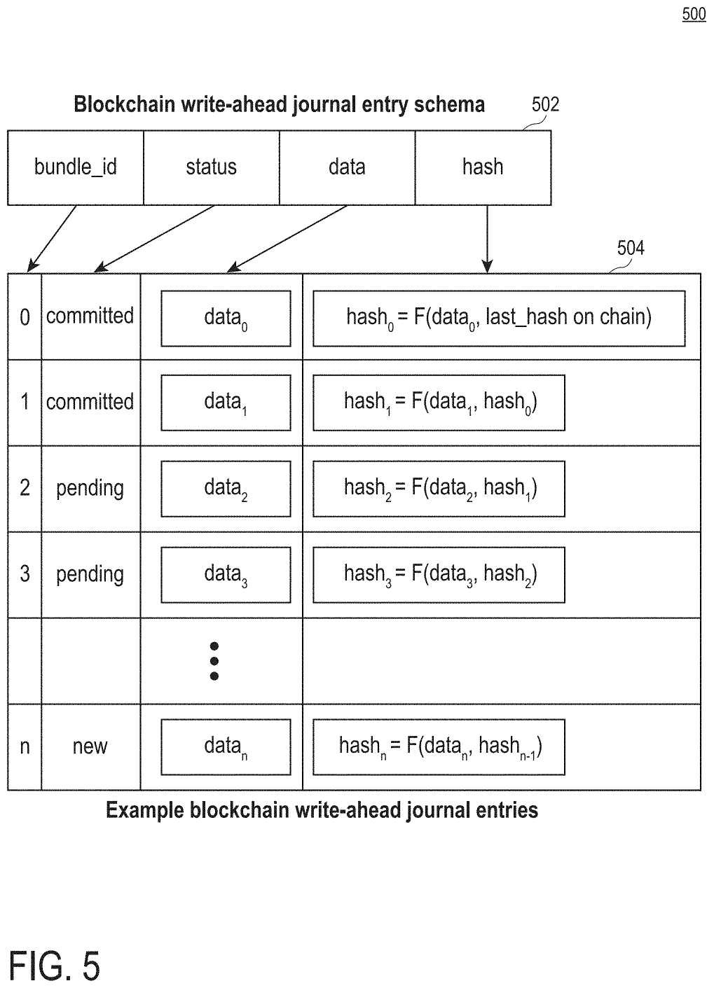

FIG. 5 is a schematic diagram 500 of a blockchain write-ahead journal entry schema 502 and example journal entries 504 on a blockchain write-ahead journal in accordance with some embodiments. The schema 502 includes four components: a bundle identifier, a status, the data, and the hash digest.

Example entries in the journal are shown at 504. The entries 504 form a chain of digital signatures wherein each entry, and thus the entry's hash, includes the hash of the immediately preceding entry. Accordingly, making a change to an earlier link in the chain of digital signatures would require re-computing all the hashes and changing all subsequent links in the chain.

The entries 504 have status indicators to identify whether the mutation bundle has been committed to the chain (and is thus ready for trimming) such as bundle identifiers 0 and 1 in the entries 504. Bundle identifiers 2 and 3 in the entries 504 are marked pending as their signed blockchain transactions have been submitted to the blockchain validators but the journal has not yet received an indication they have been committed to the blockchain. Bundle identifier n in the entries 504 is marked new, meaning a signed blockchain transaction for the nth bundle has not yet been signed and broadcast to the blockchain network.

As is possible on any computing system, the host computing system could crash while filesystem operation represented by entries in the write-ahead blockchain journal are in progress. As such, the write-ahead blockchain journal may, upon startup, check whether a crash condition may have been satisfied. In one example, the write-ahead blockchain journal replays the entries in the journal against the blockchain to determine whether any entries in the write-ahead blockchain journal are stale entries by checking whether a hash digest of each entry in the write-ahead journal exists on the blockchain. If any stale entries are encountered (e.g., a hash digest for an entry also exists on the blockchain), then that entry's trimming operation was likely interrupted by the system crash. The journal will trim any such stale entries and bring the journal into synchronization with the volume on the blockchain.

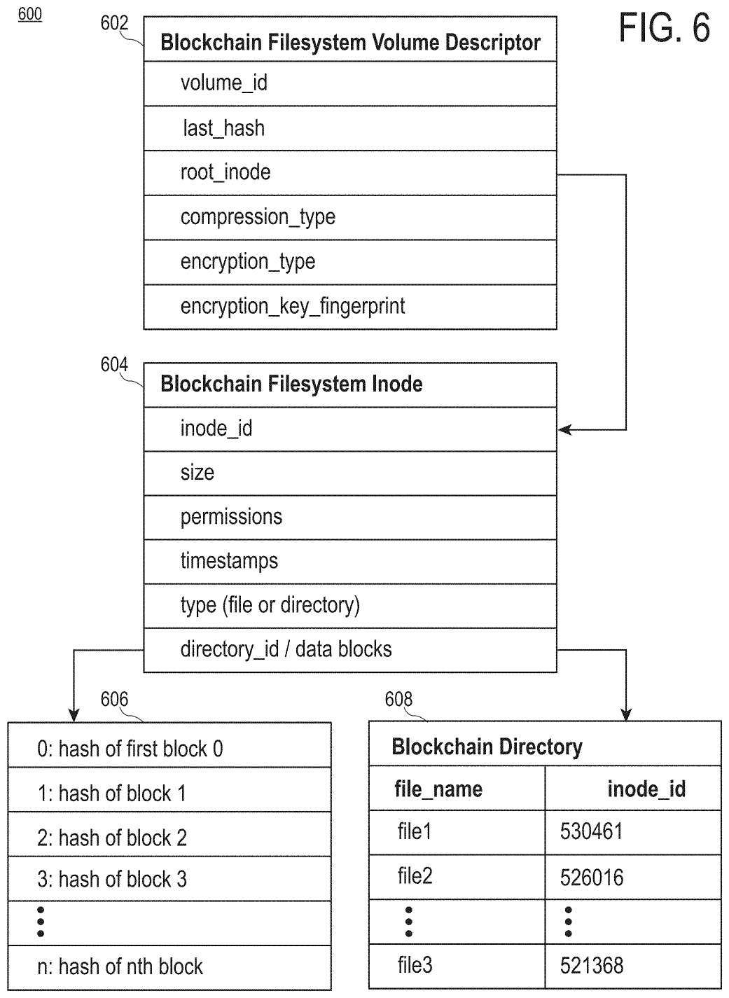

FIG. 6 is a schematic diagram 600 of a blockchain filesystem volume descriptor 602, a blockchain filesystem inode 604, a data blocks field 606 and a blockchain directory 608 in accordance with some embodiments. The volume descriptor 602 can be viewed as the “super block” for this volume. The volume descriptor 602 is a data structure that includes the various entries: root inode, compression type, encryption type, and encryption key fingerprint. The last hash entry is the hash digest of the last data block synchronized from the blockchain filesystem kernel module write-ahead journal. The write-ahead journal can use the last hash if its queue is empty and it needs to link a new mutation bundle in a chain of digital signatures. The other entries in the volume descriptor 602 include information needed by host computing systems to decompress and decrypt the data stored therein. The encryption key fingerprint is an identifier for the private key so that the host computing system knows which private key encrypted the files on the blockchain.

An important feature of this structure is the pointer to the blockchain filesystem inode 604, which is an inode id or inode number that points to a structure of type inode (e.g., to the blockchain address location of the inode). The blockchain filesystem inode 604 includes components familiar to filesystems including the size of the inode, permission settings for modifying the inode, timestamps, whether the inode is a file or directory, and the address of the directory or file to which the inode points.

In Unix-style file systems, the data blocks in a directory, instead of containing file data, would contain the directory tables. The present blockchain filesystem functions differently by having two distinct structures: data blocks 606 or a blockchain directory 608. The box labeled “directory_id/data blocks” in blockchain filesystem inode 604 can include either a pointer to a blockchain data block or a pointer to a blockchain directory. In other words, “directory_id/data blocks” can be mutually exclusive in a given blockchain filesystem inode.

If the blockchain filesystem inode 604 is a directory, the directory_id field points to the blockchain directory 608. The blockchain directory 608 is an array of mappings between file name and inode identifier. If the blockchain filesystem inode 604 is a file, the data blocks 606 entry points to a map wherein the keys of the map are integers that represent logical block numbers of the file represented by the inode. Since a file can be viewed as a sequence of bytes, each logical block number points to the start of its corresponding array of bytes in the file. In the example illustrated in 606, each of the blocks is 512 bytes long. The 0th entry points to the address of the beginning of the first 512 byte block of the file, the 1st entry points to the next 512 byte block of the file, and so forth up to the nth block of the file. The numeric integer key represents the logical block number in the sequence of the file and it has a map to the actual content hash of the data block.

The data block 606 differs from a conventional mounted disk with logical block addresses because the blockchain filesystem is a content-addressed system. Instead of the integer keys being mapped to logical block addresses, the keys are mapped to the hash digest of the data. Thus locating the referenced data on the blockchain involves searching for the hash digest of the content rather than searching a logical block address table to find a physical address as would be the case in a conventional file system. In the scenario of a write request from the host computing system that is a random write request to data at a block of the data blocks 606 keyed to a specific integer, the components to the data structures that would be updated upon confirmation to the blockchain of the random write request would be the inode to reflect a block had changed and the integer keyed data block would be read, modified according to the random write request, and written again to the blockchain. When the integer keyed block is re-written with the update, the block's hash digest will change. In the scenario of a write request from the host computing system to the data blocks 606 contained in the blockchain filesystem inode 604, the specific data block would be read, modified according to the write request, and written to the blockchain. The components of the blockchain filesystem inode 604, such as size, would be updated The updated block's hash digest will be stuck back into the map at the keyed integer location to reference the new data now stored on the blockchain. In this random write example, the original data block at the keyed integer would still exist on the blockchain, and another inode may even have a reference to it.

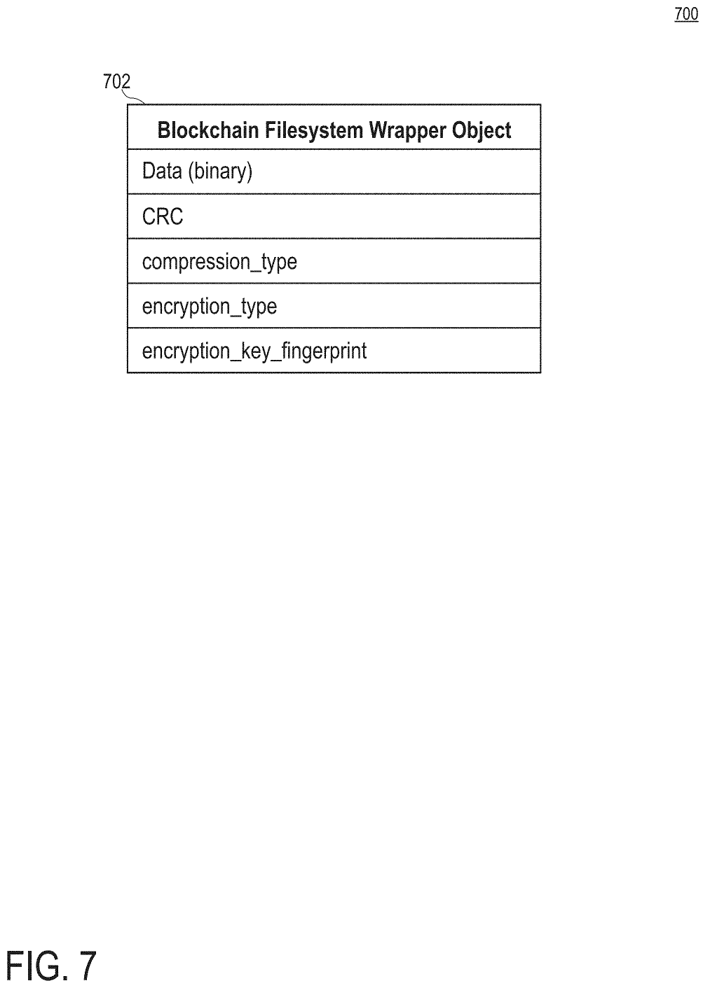

FIG. 7 is a schematic diagram 700 of a blockchain filesystem wrapper object 702 in accordance with some embodiments. The blockchain filesystem wrapper object 702 surrounds the filesystem data stored on the blockchain, including if the filesystem data from the host computing system is encrypted or compressed on the blockchain. The wrapper object 702 includes a data section, which is the binary data that is stored on-chain. As explained below, the data section could be encrypted and/or compressed, in which the data section will appear to be an encrypted blob to any observers of the wrapper object 702 on the blockchain, which is likely maintained by a network of peer-to-peer nodes that have access to chain content.

One feature included in the blockchain filesystem wrapper object 702 is a redundancy check. In the example illustrated in FIG. 7, the redundancy check is a cyclic redundancy check (CRC). The CRC is an error detecting code (e.g., a code based on the remainder of a polynomial division of the contents of the wrapper object) to ensure that the contents of the wrapper are decoded properly. The CRC value is added to the wrapper objects 702 upon creation, such as by the host computing system. The CRC value is computed over the raw, unencoded object data before the data is encoded (and possibly compressed and/or encrypted) and placed into the wrapper 702. When another participant eventually reads the wrapper 702 and decodes its contained object data, the CRC is again computed and compared to the value stored in the wrapper 702 to ensure that the decoding was performed correctly.

Other features of the wrapper object 702 are a compression type and encryption type. When a participant in the system, such as the host computing system, reads data off the blockchain, the compression type and encryption type lets the host computing system know whether the data is compressed and/or encrypted such that the data can be decrypted and decompressed by the host computing system for its filesystem operations. The compression type and encryption type fields also include information that the host computing system uses to determine which key is needed to decrypt the stored data.

An encryption key fingerprint may also be included in the wrapper object 702. The encryption key fingerprint is a feature that allows a host computing system to read a copy of the blockchain on which the files are stored and determine which blobs of data the host computing system can decrypt. In other words, the host computing system can parse the entire blockchain, looking for encryption key fingerprints that match its own private encryption keys. The matching wrapper objects thus inform the host computing system which data on the chain “belong” to the host computing system and not another computing system using the same blockchain to store its filesystem. In one implementation, the encryption key fingerprint is a SHA256 hash of an AES-GCM blockcypher key.

An issue arises if the filesystem volume changes from one compression and/or encryption algorithm to another. If data is stored and/or encrypted according to a first method, and stored on the blockchain using the algorithm associated with that method, and later the host computing system chooses to “re-key” to another encryption and/or compression method, the earlier-stored encrypted and/or compressed data blocks will not be decipherable under the new method. It is likely not economical for the filesystem to re-write all prior data again to the blockchain according to the new encryption and/or compression method. The filesystem must thus know what earlier setting was used. On the fly, the filesystem can thus scan the blockchain and quickly and economically identify which key (if any) must be used to operate on the pre-switch data. In this way, the filesystem can still use data that was written to an “immutable” blockchain.

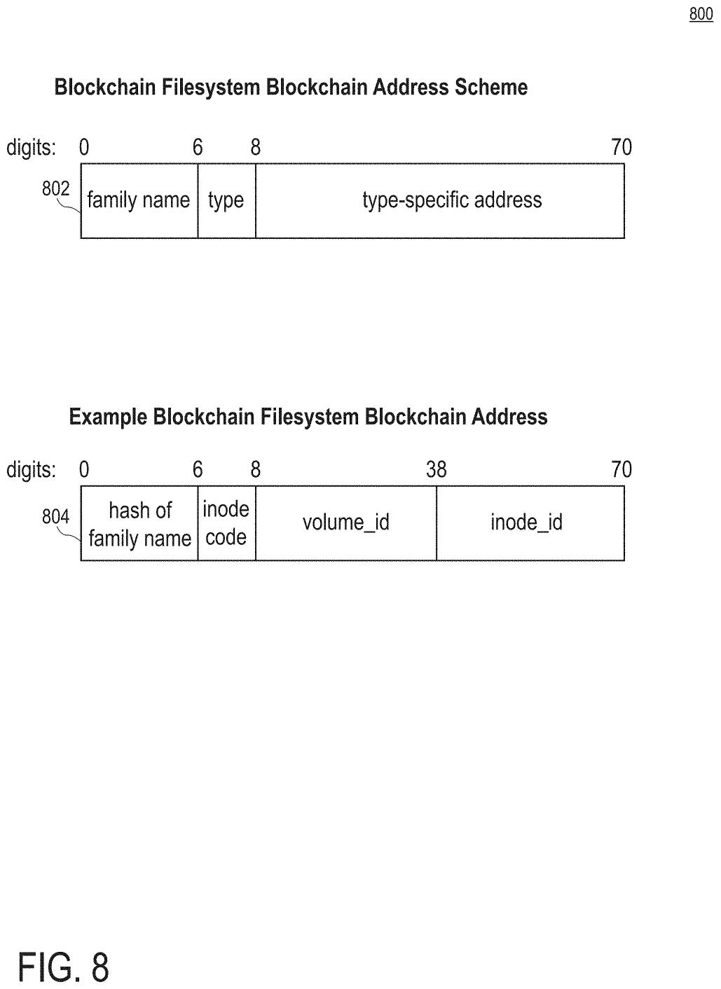

FIG. 8 is a schematic diagram 800 of a blockchain filesystem blockchain address format in accordance with some embodiments. The schema 802 can be viewed as a lookup key for a piece of data on the blockchain. In the example illustrated in FIG. 8, the schema 802 is chosen based in part on the requirements of a Hyperledger Sawtooth™ blockchain in which addresses are 70 hexadecimal digit byte strings. The first six digits are a hash of the family name. The filesystem may have a name (e.g., TechCorp FS), which can be hashed (e.g., a SHA-256 hashing algorithm) to produce a hash digest, the first six digits of which become the first six digits of the address 802. The family name can aid the transaction processor or equivalent component in handling a blockchain transaction with this address.

The remaining 64 characters after the family name are thus available for addressing. In the scheme 802, the next two characters are used to indicate the type of transaction (e.g., volume, inode, data block, last hash, bundle, or any other type of on-chain data). The types can be referred to by two-digit code which in hexadecimal accommodates 256 distinct types. The remaining 62 digits are used to look up individual data objects on the blockchain depending on their type.

An example blockchain filesystem blockchain address is shown at 804. The hash of family name is the first six hexadecimal digits of the hash digest of the filesystem name and the type code is an inode. Following the two type digits are 30 digits of the volume identifier and 32 digits of the inode identifier. This format is used because an inode is always related to a volume (e.g., inodes are not shared among volumes). Thus an inode is addressed with reference to its volume and its inode identifier. The 30 digits are computed by hashing the UUID of the volume (e.g., a SHA-256 hash) and slicing off the first 30 digits. Then the inode identifier UUID is hashed and the first 32 digits are sliced off. The two truncated hash digests are then concatenated to form the last 62 digits of the example blockchain filesystem blockchain address.

The full concatenation of the four parts results in a hexadecimal string of 70 digits. If the blockchain is searched for this 70-digit string, it will return the blockchain object wrapper and inside the wrapper will be the inode that represents the content-addressed data such as the example blockchain object wrapper described with respect to FIG. 7.

One important feature of the blockchain filesystem addressing scheme example in FIG. 8 is that it allows implementation of an access control list (ACL) or public key whitelist for interaction with a particular volume. A blockchain transaction including the blockchain address 804, for example, can be computationally trivially checked whether the private key that signed the blockchain transaction to the address 804 is paired with a public key on the ACL or whitelist. That the volume id is contained in the blockchain address of the transaction itself facilitates referencing the volume id to the whitelist.

As an example of the operation of the whitelist, imagine an attacker created an adversarial bundle and tried to confirm it to the blockchain to modify data for which the attacker is unauthorized. Normally, all the contents of a mutation bundle will modify something on the filesystem (inode, data block, etc.) having to do with the relevant open volume. If the attacker's mutation bundle tries to modify an inode in another volume, the attack transaction could potentially be a valid blockchain transaction and therefore be shared in the mempool among the network nodes. When the attack transaction arrives at the transaction processor (or equivalent component), the volume requested to be written to will be inside the blockchain address and will be checked that it is signed by a key whitelisted for that volume. When it is determined that the bundle has a commit that is not for its mounted volume, it can be rejected as an invalid bundle.

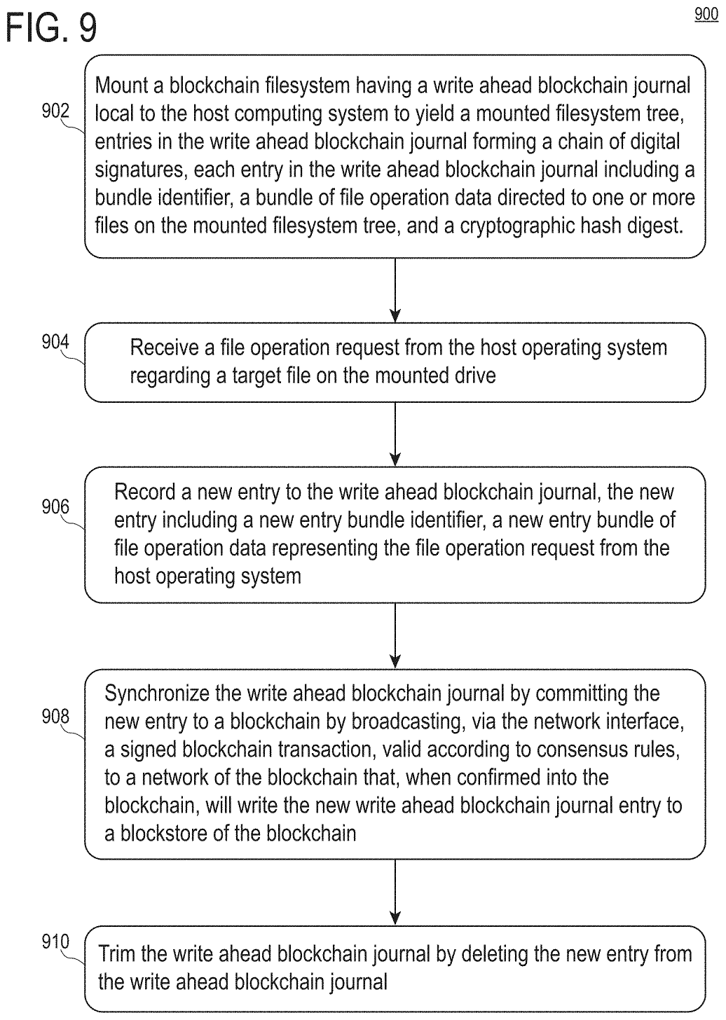

FIG. 9 is a flowchart diagram 900 of a host computing system workflow for a blockchain filesystem in accordance with some embodiments. A mounting operation 902 mounts a blockchain filesystem having a write-ahead blockchain journal local to the host computing system to yield a mounted filesystem tree. The mounted file system tree can be interacted with by user space applications running on the host computing system in the same way the user space applications would interact with a conventional filesystem. The user space applications need not even be aware that the filesystem they have mounted is the blockchain file system and not a conventional filesystem. The mounting operation 902 further includes that entries in the write-ahead blockchain journal form a chain of digital signatures, each entry in the write-ahead journal including a bundle identifier, a bundle of file operation data directed to one or more files on the mounted filesystem tree, and a cryptographic hash digest, the cryptographic hash digest being formed as a function of: (1) the bundle of file operation data in the entry, and (2) a hash digest of an immediately previous entry in the chain of digital signatures.

The next operation in the workflow 900 is a receiving operation 904 that receives a file operation request from the host operating system regarding a target file on the mounted drive. The file operation request may be any of the typical file operations including open, write, touch, stat, delete, read, etc. A recording operation 906 records a new entry to the write-ahead blockchain journal, the new entry including a new entry bundle identifier, a new entry bundle of file operation data representing the file operation request from the host operating system, and a new entry cryptographic hash digest computed as a function of: (1) the bundle of file operation data representing the file operation request from the host operating system and (2) the hash digest of a journal entry immediately preceding the new entry.

The next operation is a synchronization operation that synchronizes write-ahead blockchain journal by committing the new entry to a blockchain by broadcasting, via the network interface, a signed blockchain transaction, valid according to consensus rules, to a network of the blockchain that, when confirmed into the blockchain, will write the new write-ahead blockchain journal entry to a blockstore of the blockchain. Finally a trim operation 910 trims the write-ahead blockchain journal by deleting the new entry, now marked committed, from the write-ahead blockchain journal.

The IPFS (InterPlanetary File System) is an internet wide filesystem using a distributed hash table to address information throughout the internet on various computers that are not necessarily controlled by IPFS. The intent is to make files over the internet easy to store and find remotely across the entire internet. Blockchain filesystem is a write once read many local filesystem that is distributed and secured using a blockchain with complete copies of the local filesystem on every node.

STORJ is a peer-to-peer cloud storage network implementing client-side encryption to allow users to transfer and share data without reliance on a third party storage provider. Though it uses a blockchain to ensure the integrity of the data stored on the peer-to-peer network has not changed, it is not using a filesystem on local blockchain nodes for organization, deduplication and retrieval. Another key difference is STORJ fragments the files across multiple computers that it has no control over using a peer-to-peer scheme. Blockchain filesystem keeps its files on a blockchain that is replicated on additional distributed nodes, each having a complete copy of the contents of the blockchain filesystem.

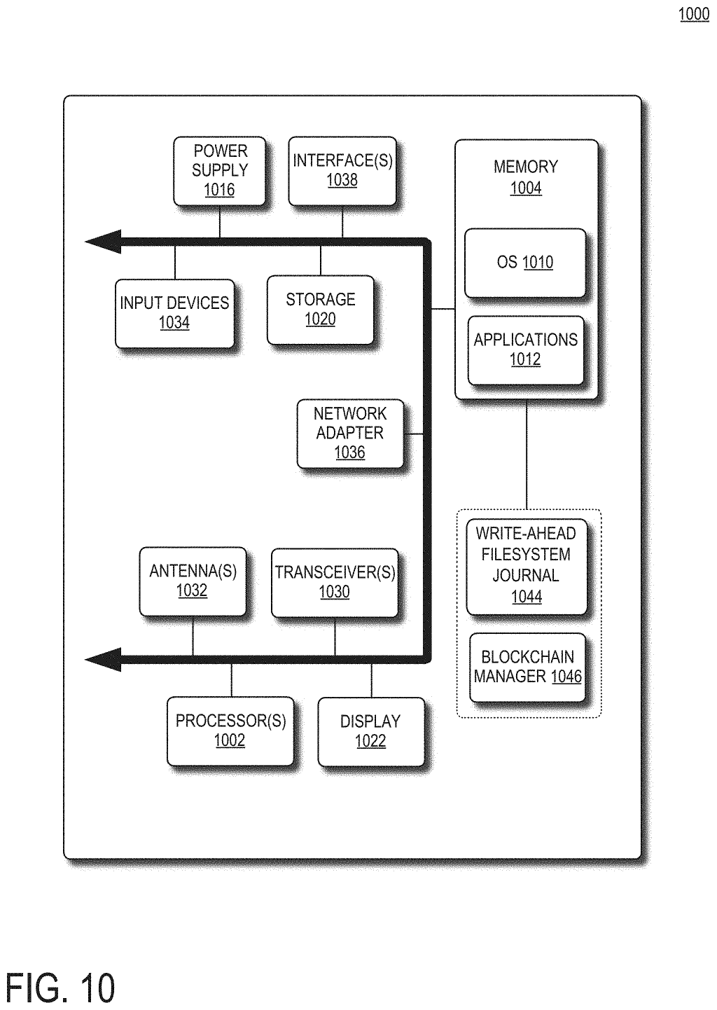

FIG. 10 is a diagram 1000 of a system that may be useful in implementing the blockchain file system and/or the host computing system in accordance with some embodiments. FIG. 10 illustrates an example system (labeled as a processing system 1000) that may be useful in implementing the described technology. The processing system 1000 may be a client device, such as a smart device, connected device, Internet of Things (IoT) device, laptop, mobile device, desktop, tablet, or a server/cloud device. The processing system 1000 includes one or more processor(s) 1002, and a memory 1004. The memory 1004 generally includes both volatile memory (e.g., RAM) and non-volatile memory (e.g., flash memory). An operating system 1010 resides in the memory 1004 and is executed by the processor 1002.

One or more application programs 1012 modules or segments, such as write-ahead filesystem journal 1044 and blockchain manager 1046 are loaded in the memory 1004 and/or storage 1020 and executed by the processor 1002. In some implementations, the write-ahead filesystem journal 1044 is stored in read-only memory (ROM) 1014 or write once, read many (WORM) memory. Data such as extrinsic event data sources may be stored in the memory 1004 or storage 1020 and may be retrievable by the processor 1002 for use by write-ahead filesystem journal 1044 and the blockchain manager 1046, etc. The storage 1020 may be local to the processing system 1000 or may be remote, and communicatively connected to, the processing system 1000, and may include another server. The storage 1020 may store resources that are requestable by client devices (not shown). The storage 1020 may include secure storage, such as one or more platform configuration registers (PCR) managed by one or more trusted platform modules (TPMs), which may be implemented in a chip, or by the trusted execution environment (TEE).

The processing system 1000 includes a power supply 1016, which is powered by one or more batteries, or other power sources, and which provides power to other components of the processing system 1000. The power supply 1016 may also be connected to an external power source that overrides or recharges the built-in batteries or other power sources.

The processing system 1000 may include one or more communication transceivers 1030 which may be connected to one or more antenna(s) 1032 to provide network connectivity (e.g., mobile phone network, Wi-Fi®, Bluetooth®, etc.) to one or more other servers and/or client devices (e.g., mobile devices, desktop computers, or laptop computers). The processing system 1000 may further include a network adapter 1036, which is a type of communication device. The processing system 1000 may use the network adapter 1036 and any other types of communication devices for establishing connections over a wide-area network (WAN) or local area network (LAN). It should be appreciated that the network connections shown are exemplary, and that other communications devices, and means for establishing a communications link between the processing system 1000 and other devices, may be used.

The processing system 1000 may include one or more input devices 1034 such that a user may enter commands and information (e.g., a keyboard or mouse). Input devices 1034 may further include other types of input such as multimodal input, speech input, graffiti input, motion detection, facial recognition, physical fingerprinting, etc. These and other input devices may be coupled to the server by one or more interfaces 1038, such as a serial port interface, parallel port, universal serial bus (USB), etc. The processing system 1000 may further include a display 1022, such as a touch screen display.

The processing system 1000 may include a variety of tangible processor-readable storage media and intangible processor-readable communication signals including a virtual and/or cloud computing environment. Tangible processor-readable storage can be embodied by any available media that can be accessed by the processing system 1000, and includes both volatile and nonvolatile storage media, and removable and non-removable storage media. Tangible processor-readable storage media excludes intangible communications signals and includes volatile and nonvolatile, removable and non-removable, storage media implemented in any method or technology for storage of information such as processor-readable instructions, data structures, program modules, or other data. Tangible processor-readable storage media includes, but is not limited to, RAM, ROM, EEPROM, flash memory, or other memory technology, CDROM, digital versatile disks (DVD), or other optical disk storage, magnetic cassettes, magnetic tape, magnetic disk storage, or other magnetic storage devices, or any other tangible medium which can be used to store the desired information, and which can be accessed by the processing system 1000. In contrast to tangible processor-readable storage media, intangible processor-readable communication signals may embody computer-readable instructions, data structures, program modules, or other data resident in a modulated data signal, such as a carrier wave, or other signal transport mechanisms. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A blockchain computer filesystem, the computer filesystem comprising:
a host computing system including one or more processors, a network interface, and a computer readable medium storing a host operating system and user space applications that, when executed by the one or more processors, causes the one or more processors to perform operations comprising:
mount a blockchain filesystem having a write-ahead blockchain journal local to the host computing system to yield a mounted filesystem tree, entries in the write-ahead blockchain journal forming a chain of digital signatures, each entry in the write-ahead blockchain journal including a bundle identifier, a bundle of file operation data directed to one or more files on the mounted filesystem tree, and a cryptographic hash digest, the cryptographic hash digest being formed as a function of: (1) the bundle of file operation data in the entry, and (2) a hash digest of an immediately previous entry in the chain of digital signatures;
receive a file operation request from the host operating system regarding a target file on the mounted drive;
record a new entry to the write-ahead blockchain journal, the new entry including a new entry bundle identifier, a new entry bundle of file operation data representing the file operation request from the host operating system, and a new entry cryptographic hash digest computed as a function of: (1) the bundle of file operation data representing the file operation request from the host operating system and (2) the hash digest of a journal entry immediately preceding the new entry;
synchronize the write-ahead blockchain journal by committing the new entry to a blockchain by broadcasting, via the network interface, a signed blockchain transaction, valid according to consensus rules, to a network of the blockchain that, when confirmed into the blockchain, will write the new write-ahead blockchain journal entry to a blockstore of the blockchain; and
trim the write-ahead blockchain journal by deleting the new entry from the write-ahead blockchain journal.

2. The computing system of claim 1, wherein the instructions cause the one or more processors to perform operations further comprising:
receive a read file operation request from the host operating system, regarding a target read file on the mounted drive, the read file operation request including a blockheight of the blockchain;
search the blockchain for the target read file as it existed at the blockheight to yield a snapshotted target read file; and
return the snapshotted target read file to the host operating system.

3. The computing system of claim 1, wherein a blockchain transaction processor:
receives the signed blockchain transaction but does not write the new write-ahead blockchain journal entry data to the blockstore if a cryptographic hash digest fingerprint of the new write-ahead blockchain journal entry data satisfies a match condition with a cryptographic hash digest fingerprint of existing data on the blockstore; and
writes a copy-on-write update to an inode implicated by the new write-ahead blockchain journal entry data to point to an address of the existing data on the blockstore.

4. The computing system of claim 1, wherein the instructions cause the one or more processors to perform operations further comprising:
detect that a crash condition may have been satisfied;
replay the write-ahead blockchain journal against a copy of the blockchain to determine whether any entries in the write-ahead blockchain journal are stale entries by checking whether a hash digest of each entry in the write-ahead journal exists on the blockchain; and
trim the stale entries from the write-ahead blockchain journal.

5. The computing system of claim 1, wherein the operation that synchronizes the write-ahead blockchain journal by committing the new entry to a blockchain writes a wrapper object to the blockstore, the wrapper object including at least a compression type, an encryption type, and an encryption key fingerprint of the file operation data.

6. The computing system of claim 1, wherein the signed blockchain transaction is formatted according to an addressing scheme that reserves a set of hexadecimal digits for a family name, a set of hexadecimal digits for a type, and a set of digits for a type-specific address, the type-specific address including a volume identifier and an inode identifier.

7. The computing system of claim 1, wherein the operation that synchronizes the write-ahead blockchain journal by committing the new entry to a blockchain by broadcasting, via the network interface, a signed blockchain transaction does not include a lockfile.

8. The computing system of claim 1, wherein the instructions cause the one or more processors to perform operations further comprising:
request, from a user of the host operating system, write-ahead journal synchronization parameters including at least one of: maximum blockchain transaction fee accompanying the signed blockchain transaction, minimum number of journal entries to batch into the signed blockchain transaction, and a cooldown period between consecutive write-ahead journal synchronizations.

9. A method of confirming filesystem operations to a blockchain file system, the method comprising:
mount a blockchain filesystem having a write-ahead blockchain journal local to the host computing system to yield a mounted filesystem tree, entries in the write-ahead blockchain journal forming a chain of digital signatures, each entry in the write-ahead blockchain journal including a bundle identifier, a bundle of file operation data directed to one or more files on the mounted filesystem tree, and a cryptographic hash digest, the cryptographic hash digest being formed as a function of: (1) the bundle of file operation data in the entry, and (2) a hash digest of an immediately previous entry in the chain of digital signatures;
receive a file operation request from the host operating system regarding a target file on the mounted drive;
record a new entry to the write-ahead blockchain journal, the new entry including a new entry bundle identifier, a new entry bundle of file operation data representing the file operation request from the host operating system, and a new entry cryptographic hash digest computed as a function of: (1) the bundle of file operation data representing the file operation request from the host operating system and (2) the hash digest of a journal entry immediately preceding the new entry;
synchronize the write-ahead blockchain journal by committing the new entry to a blockchain by broadcasting, via the network interface, a signed blockchain transaction, valid according to consensus rules, to a network of the blockchain that, when confirmed into the blockchain, will write the new write-ahead blockchain journal entry to a blockstore of the blockchain; and
trim the write-ahead blockchain journal by deleting the new entry from the write-ahead blockchain journal.

10. The method of claim 9, further comprising:
receiving a read file operation request from the host operating system, regarding a target read file on the mounted drive, the read file operation request including a blockheight of the blockchain;
searching the blockchain for the target read file as it existed at the blockheight to yield a snapshotted target read file; and
returning the snapshotted target read file to the host operating system.

11. The method of claim 9, wherein a blockchain transaction processor:
receives the signed blockchain transaction but does not write the new write-ahead blockchain journal entry data to the blockstore if a cryptographic hash digest fingerprint of the new write-ahead blockchain journal entry data satisfies a match condition with a cryptographic hash digest fingerprint of existing data on the blockstore; and
writes a copy-on-write update to an inode implicated by the new write-ahead blockchain journal entry data to point to an address of the existing data on the blockstore

12. The method of claim 9, further comprising:
detect that a crash condition may have been satisfied;
replay the write-ahead blockchain journal against a copy of the blockchain to determine whether any entries in the write-ahead blockchain journal are stale entries by checking whether a hash digest of each entry in the write-ahead journal exists on the blockchain; and
trim the stale entries from the write-ahead blockchain journal.

13. The method of claim 9, wherein the operation that synchronizes the write-ahead blockchain journal by committing the new entry to a blockchain writes a wrapper object to the blockstore, the wrapper object including at least a compression type, an encryption type, and an encryption key fingerprint of the file operation data.

14. The method of claim 9, wherein the operation that synchronizes the write-ahead blockchain journal by committing the new entry to a blockchain by broadcasting, via the network interface, a signed blockchain transaction does not include a lockfile.

15. A kernel blockchain filesystem module having a write-ahead blockchain journal for queuing mutations to a blockchain filesystem volume, the kernel blockchain file module being configured to:
mount a blockchain filesystem having a write-ahead blockchain journal local to the host computing system to yield a mounted filesystem tree, entries in the write-ahead blockchain journal forming a chain of digital signatures, each entry in the write-ahead blockchain journal including a bundle identifier, a bundle of file operation data directed to one or more files on the mounted filesystem tree, and a cryptographic hash digest, the cryptographic hash digest being formed as a function of: (1) the bundle of file operation data in the entry, and (2) a hash digest of an immediately previous entry in the chain of digital signatures;
receive a file operation request from the host operating system regarding a target file on the mounted drive;
record a new entry to the write-ahead blockchain journal, the new entry including a new entry bundle identifier, a new entry bundle of file operation data representing the file operation request from the host operating system, and a new entry cryptographic hash digest computed as a function of: (1) the bundle of file operation data representing the file operation request from the host operating system and (2) the hash digest of a journal entry immediately preceding the new entry;
synchronize the write-ahead blockchain journal by committing the new entry to a blockchain by broadcasting, via the network interface, a signed blockchain transaction, valid according to consensus rules, to a network of the blockchain that, when confirmed into the blockchain, will write the new write-ahead blockchain journal entry to a blockstore of the blockchain; and
trim the write-ahead blockchain journal by deleting the new entry from the write-ahead blockchain journal

16. The kernel blockchain filesystem module of claim 15, wherein the kernel blockchain file module is further configured to:
request, from a user of the host operating system, write-ahead journal synchronization parameters including at least one of: maximum blockchain transaction fee accompanying the signed blockchain transaction, minimum number of journal entries to batch into the signed blockchain transaction, and a cooldown period between consecutive write-ahead journal synchronizations.

17. The kernel blockchain filesystem module of claim 15, wherein the kernel blockchain file module is further configured to:
receiving a read file operation request from the host operating system, regarding a target read file on the mounted drive, the read file operation request including a blockheight of the blockchain;
searching the blockchain for the target read file as it existed at the blockheight to yield a snapshotted target read file; and
returning the snapshotted target read file to the host operating system.

18. The kernel blockchain filesystem module of claim 15, wherein the kernel blockchain file module is further configured to:
detect that a crash condition may have been satisfied;
replay the write-ahead blockchain journal against a copy of the blockchain to determine whether any entries in the write-ahead blockchain journal are stale entries by checking whether a hash digest of each entry in the write-ahead journal exists on the blockchain; and
trim the stale entries from the write-ahead blockchain journal.

19. The kernel blockchain filesystem module of claim 15, wherein the operation that synchronizes the write-ahead blockchain journal by committing the new entry to a blockchain writes a wrapper object to the blockstore, the wrapper object including at least a compression type, an encryption type, and an encryption key fingerprint of the file operation data.

20. The kernel blockchain filesystem module of claim 15, wherein the operation that synchronizes the write-ahead blockchain journal by committing the new entry to a blockchain by broadcasting, via the network interface, a signed blockchain transaction does not include a lockfile.
